(19) United States
(12) Patent Application Publication
(10) Pub. No.: US 2019/0025617 A1
(43) Pub. Date: Jan. 24, 2019

(54) TEMPERATURE CONTROL ALIGNMENT DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Xiang LI, Shenzhen (CN); Chung-Ching HSIEH, Shenzhen (CN)

(21) Appl. No.: 15/572,500

(22) PCT Filed: Sep. 11, 2017
(86) PCT No.: PCT/CN2017/101169

§ 371 Date: Nov. 8, 2017

(30) Foreign Application Priority Data
Jul. 19, 2017 (CN) 201710592157.1

(51) Int. Cl. G02F 1/13; G02F 1/1337

(52) U.S. Cl. CPC G02F 1/1303; G02F 1/13378

(57) ABSTRACT

A temperature control alignment device includes a machine divided into at least two areas, a plurality of heating modules, and a plurality of moving modules. Each of the heating modules corresponds to each of the areas of the machine. Each of the moving modules corresponds to each of the areas of the machine. Liquid crystal panels having different characteristic parameters are disposed on the adjacent areas of the machine, such that the liquid crystal panels disposed on the different areas of the machine have different temperatures. The liquid crystal panels having the same characteristic parameters are disposed on adjacent areas of the machine, such that the liquid crystal panels disposed on different areas of the machine have a same temperature.

### FIELD OF THE INVENTION

The present disclosure relates to the field of liquid crystal panels, and more particularly to a temperature control alignment device.

### BACKGROUND OF THE INVENTION

With living standards of people improving, large-size liquid crystal display televisions (LCD TVs) are increasingly popular with consumers. LCD TVs, from small to large, have become a trend, therefore, large-size panel production has a good market and development. However, due to limitations of generation lines, a production only for a single size of large-size panels results in low utilization of large plates, high production costs, and other economic benefit problems, thus limiting market development.

Multi model group (MMG) technology is used to improve defects. That is, different sizes of two LCD panels are mixed designed on a same glass substrate, thus greatly improving utilization of glass substrates. For example, in a G8.5 generation line, a utilization rate for only cutting 43-inch LCD panels is only 75%, while a utilization rate for cutting the 43-inch LCD panels and 22-inch LCD panels is 97%.

However, in the MMG technology, due to pixel densities and aperture rates of transistors of the two liquid crystal panels not being same and the use of conventional liquid crystal alignment curing technology, alignments of two products are not compatible. An excessive alignment causes a pre-tilt angle to be too large, a dark state to be bright, and contrast to be too small. An insufficient alignment causes the pre-tilt angle to be too small, liquid crystal diffusion is poor when the liquid crystal is pressed, and residual images occur.

Therefore, it is necessary to provide a temperature control alignment device to solve the problems existing in the conventional technologies.

### SUMMARY OF THE INVENTION

An object of the present disclosure is to provide a temperature control alignment device capable of solving the incompatibility of liquid crystal panels having different sizes on a substrate due to the use of multi model group (MMG) technology.

To achieve the above object, an embodiment of the present disclosure provides a temperature control alignment device, which includes:

a machine divided into at least two areas;

a plurality of heating modules, each of the heating modules corresponding to each of the areas of the machine; and

a plurality of moving modules, each of the moving modules corresponding to each of the areas of the machine;

wherein adjacent heating modules are connected together by the moving modules when a plurality of liquid crystal panels having same characteristic parameters are disposed on adjacent areas of the machine, and any one of the heating modules makes the liquid crystal panels disposed on different areas of the machine have a same temperature;

wherein the adjacent heating modules are separated by the moving modules when the liquid crystal panels having different characteristic parameters are disposed on the adjacent areas of the machine, and corresponding heating modules make the liquid crystal panels disposed on the different areas of the machine have different temperatures;

wherein each of the heating modules provides a temperature between 20 degrees Celsius and 50 degrees Celsius; each of the heating modules includes a thermally conductive sheet disposed at a bottom of the machine and matching a size of a corresponding area of the machine, a liquid conduit in contact with the thermally conductive sheet, and an electric heater in contact with liquid in the liquid conduit, and the electric heater is configured to heat the liquid.

In the temperature control alignment device of an embodiment of the present disclosure, a difference between temperatures provided by the adjacent heating modules is between 10 degrees Celsius and 20 degrees Celsius when the liquid crystal panels having different characteristic parameters are disposed on the adjacent areas of the machine.

In the temperature control alignment device of an embodiment of the present disclosure, each of the moving modules is connected to the thermally conductive sheet of a corresponding heating module.

In the temperature control alignment device of an embodiment of the present disclosure, the moving modules combine adjacent thermally conductive sheets together to make the thermally conductive sheets have a same temperature when the liquid crystal panels having the same characteristic parameters are disposed on the adjacent areas of the machine.

In the temperature control alignment device of an embodiment of the present disclosure, the moving modules separate adjacent thermally conductive sheets to make the thermally conductive sheets have different temperatures when the liquid crystal panels having the different characteristic parameters are disposed on the adjacent areas of the machine.

In the temperature control alignment device of an embodiment of the present disclosure, each of the thermally conductive sheets is a copper sheet or an aluminum sheet.

In the temperature control alignment device of an embodiment of the present disclosure, each of the heating modules further includes a controller connected to the electric heater for controlling a temperature of the electric heater.

In the temperature control alignment device of an embodiment of the present disclosure, each of the heating modules further includes a temperature sensor disposed in the liquid conduit, and the temperature sensor is connected to the controller.

An embodiment of the present disclosure further provides a temperature control alignment device, which includes:

a machine divided into at least two areas;

a plurality of heating modules, each of the heating modules corresponding to each of the areas of the machine; and

a plurality of moving modules, each of the moving modules corresponding to each of the areas of the machine;

wherein adjacent heating modules are connected together by the moving modules when a plurality of liquid crystal panels having same characteristic parameters are disposed on adjacent areas of the machine, and any one of the heating modules makes the liquid crystal panels disposed on different areas of the machine have a same temperature;

wherein the adjacent heating modules are separated by the moving modules when the liquid crystal panels having different characteristic parameters are disposed on the adjacent areas of the machine, and corresponding heating modules make the liquid crystal panels disposed on the different areas of the machine have different temperatures.

In the temperature control alignment device of an embodiment of the present disclosure, each of the heating modules provides a temperature between 20 degrees Celsius and 50 degrees Celsius.

In the temperature control alignment device of an embodiment of the present disclosure, a difference between temperatures provided by the adjacent heating modules is between 10 degrees Celsius and 20 degrees Celsius when the liquid crystal panels having different characteristic parameters are disposed on the adjacent areas of the machine.

In the temperature control alignment device of an embodiment of the present disclosure, an alignment temperature on a large-size liquid crystal panel is less than an alignment temperature on a small-sized liquid crystal panel when the liquid crystal panels having different sizes are disposed on the adjacent areas of the machine.

In the temperature control alignment device of an embodiment of the present disclosure, each of the heating modules includes a thermally conductive sheet disposed at a bottom of the machine and matching a size of a corresponding area of the machine, a liquid conduit in contact with the thermally conductive sheet, and an electric heater in contact with liquid in the liquid conduit, the electric heater is configured to heat the liquid, and a gap is between each of the thermally conductive sheets.

In the temperature control alignment device of an embodiment of the present disclosure, each of the moving modules is connected to the thermally conductive sheet of a corresponding heating module.

In the temperature control alignment device of an embodiment of the present disclosure, the moving modules combine adjacent thermally conductive sheets together to make the thermally conductive sheets have a same temperature when the liquid crystal panels having the same characteristic parameters are disposed on the adjacent areas of the machine.

In the temperature control alignment device of an embodiment of the present disclosure, the moving modules separate adjacent thermally conductive sheets to make the thermally conductive sheets have different temperatures when the liquid crystal panels having the different characteristic parameters are disposed on the adjacent areas of the machine.

In the temperature control alignment device of an embodiment of the present disclosure, each of the thermally conductive sheets is a copper sheet or an aluminum sheet.

In the temperature control alignment device of an embodiment of the present disclosure, each of the heating modules further includes a controller connected to the electric heater for controlling a temperature of the electric heater.

In the temperature control alignment device of an embodiment of the present disclosure, each of the heating modules further includes a temperature sensor disposed in the liquid conduit, and the temperature sensor is connected to the controller.

The temperature control alignment device of the embodiment of the present disclosure includes a machine divided into at least two areas, a plurality of heating modules, and a plurality of moving modules. Each of the heating modules corresponds to each of the areas of the machine. Each of the moving modules corresponds to each of the areas of the machine. Liquid crystal panels having different characteristic parameters are disposed on the adjacent areas of the machine, such that the liquid crystal panels disposed on the different areas of the machine have different temperatures, and the liquid crystal panels on the different areas form a same pre-tilt angle to improve a product performance of each product when a production of products having different sizes on a same substrate is performed. The liquid crystal panels having same characteristic parameters are disposed on adjacent areas of the machine such that the liquid crystal panels disposed on different areas of the machine have a same temperature, so as to adapt to a single size of a production of large-size panels, flexible and convenient to the production.

The technical solution, as well as other beneficial advantages, of the present disclosure will be apparent from the following detailed description of embodiments of the present disclosure, with reference to the attached drawings.

### DESCRIPTION OF THE DRAWINGS

The technical solution and the beneficial effects of the present disclosure are understood from the following detailed description with reference to the accompanying figures and embodiments.

FIG. 1 is a schematic view illustrating a temperature control alignment device according to an embodiment of the present disclosure.

FIG. 2 is a first schematic view illustrating a heating module of a temperature control alignment device according to an embodiment of the present disclosure.

FIG. 3 is a second schematic view illustrating a heating module of a temperature control alignment device according to an embodiment of the present disclosure.

### DETAILED DESCRIPTION OF THE PREFERRED EMBODIMENTS

To further expound the technical solution adopted in the present disclosure and the advantages thereof, a detailed description is given in a preferred embodiment of the present disclosure and the attached drawings. Obviously, the embodiments described herein are only a part of, but not all of, the embodiments of the present disclosure. In view of the embodiments described herein, any other embodiment obtained by a person skilled in the field without offering creative effort is included in a scope claimed by the present disclosure.

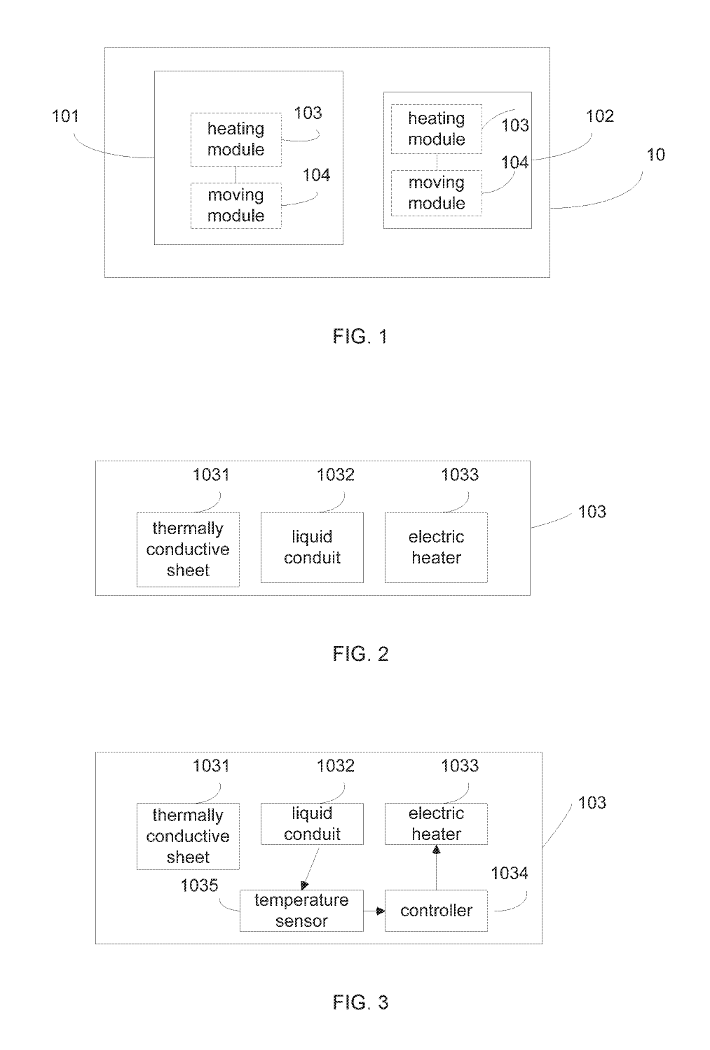

Referring to FIG. 1, a schematic view illustrating a temperature control alignment device according to an embodiment of the present disclosure is provided. Referring to FIG. 1, a temperature control alignment device of the embodiment includes a machine 10 divided into at least two areas 101 and 102, a plurality of heating modules 103, and a plurality of moving modules 104. Each of the heating modules 103 corresponds to each of the areas 101 and 102. Each of the moving modules 104 corresponds to each of the areas 101 and 102. Adjacent heating modules 103 are connected together by the moving modules 104 when a plurality of liquid crystal panels having same characteristic parameters are disposed on adjacent areas of the machine 10, and any one of the heating modules 103 makes the liquid crystal panels disposed on different areas of the machine 10 have a same temperature. The adjacent heating modules 103 are separated by the moving modules 104 when the liquid crystal panels having different characteristic parameters are disposed on the adjacent areas of the machine 10, and corresponding heating modules 103 make the liquid crystal panels disposed on the different areas of the machine 10 have different temperatures.

The existing machine is controlled by a single temperature. That is, the same machine only has one temperature. A reaction rate of a reactive monomer is highly related with a temperature of a machine. The machine of the embodiment is controlled by multi-point temperatures, temperature is used to compensate the reaction rate of the reactive monomer (the higher the temperature, the faster the reaction rate), that is, the same machine can have different temperature areas, and each of the temperature areas corresponds to different products. In this way, the reaction rate of the reactive monomer in the liquid crystal panel with different characteristic parameters is the same by the temperature, so as to form a same pre-tilt angle.

In addition, the temperature control alignment device of the embodiment of the present disclosure provides not only the heating module 103 but also the moving module 104 on each corresponding area. The heating module 103 is configured to provide a specific temperature for the liquid crystal panel on the corresponding area, and the moving module 104 is configured to connect the adjacent heating modules 103 or separate the adjacent heating modules 103. In detail, adjacent heating modules 103 are connected together by the moving modules 104 when a plurality of liquid crystal panels having the same characteristic parameters are disposed on adjacent areas of the machine 10, and any one of the heating modules 103 makes the liquid crystal panels disposed on different areas of the machine 10 have a same temperature. The adjacent heating modules 103 are separated by the moving modules 104 when the liquid crystal panels having different characteristic parameters are disposed on the adjacent areas of the machine 10, and corresponding heating modules 103 make the liquid crystal panels disposed on the different areas of the machine 10 have different temperatures.

Referring to FIG. 2, a first schematic view illustrating a heating module of a temperature control alignment device according to an embodiment of the present disclosure is provided. Referring to FIG. 2, as an embodiment of the present disclosure, the heating module 103 and the moving module 104 in the temperature control alignment device will be described in detail. The corresponding heating module 103 on each area of the temperature control alignment device includes a thermally conductive sheet 1031 disposed at a bottom of the machine 10 and matching a size of a corresponding area of the machine 10, a liquid conduit 1032 in contact with the thermally conductive sheet 1031, and an electric heater 1033 in contact with liquid in the liquid conduit 1032, and the electric heater 1033 is configured to heat the liquid.

Further, each of the moving modules 104 is disposed on each area of the temperature control alignment device. Each of the moving modules is connected to the thermally conductive sheet 1031 of a corresponding heating module 103. The moving modules 104 combine adjacent thermally conductive sheets 1031 together to make the thermally conductive sheets 1031 have a same temperature when the liquid crystal panels having the same characteristic parameters are disposed on the adjacent areas of the machine 10. The temperature is transferred to the liquid crystal panels, a reaction rate of a reactive monomer in each of the liquid crystal panels is the same under the same temperature. The moving modules 104 separate adjacent thermally conductive sheets 1031 to make the thermally conductive sheets 1031 have different temperatures when the liquid crystal panels having the different characteristic parameters are disposed on the adjacent areas of the machine 10. The temperatures are transferred to the corresponding liquid crystal panels, and reaction rates of reactive monomers in the corresponding liquid crystal panels are the same under different temperatures.

The temperature control alignment device of the embodiment of the present disclosure can be adapted to different forms of productions. In detail, the temperature control alignment device can be used to produce liquid crystal panels with the same characteristic parameters, and the temperature control alignment device can also be used to produce liquid crystal panels with different characteristic parameters, which is more flexible and convenient.

The thermally conductive sheet 1031 is a copper sheet or an aluminum sheet and has good thermal conductivity.

The temperature control alignment device of the embodiment includes a machine divided into at least two areas. A heating module and a moving module are disposed on each area. The heating module heats the different areas such that reaction rates of reactive monomers in the liquid crystal panels of different areas are the same, so as to form a same pre-tilt angle to improve a product performance of each product when a production of products having characteristic parameters on a same substrate is performed.

The heating modules 103 of the temperature control alignment device of the embodiment provides a temperature between 20 degrees Celsius and 50 degrees Celsius. The difference between temperatures provided by the adjacent heating modules 103 is between 10 degrees Celsius and 20 degrees Celsius when the liquid crystal panels having different characteristic parameters are disposed on the adjacent areas.

Referring to FIG. 3, a second schematic view illustrating a heating module of a temperature control alignment device according to an embodiment of the present disclosure is provided. Referring to FIG. 3, the heating modules 103 of the temperature control alignment device of the embodiment further includes a controller 1034 and a temperature sensor 1035 disposed in the liquid conduit 1032. The controller 1034 is connected to the electric heater 1033 for controlling a temperature of the electric heater 1033. In detail, the temperature in the liquid conduit 1032 is transferred to the controller 1034 via the temperature sensor 1035 disposed in the liquid conduit 1032, and the controller 1034 controls the electric heater 1033 to heat the liquid.

The temperature control alignment device of the embodiment of the present disclosure includes a machine divided into at least two areas, a plurality of heating modules, and a plurality of moving modules. Each of the heating modules corresponds to each of the areas of the machine. Each of the moving modules corresponds to each of the areas of the machine. Liquid crystal panels having different characteristic parameters are disposed on the adjacent areas of the machine such that the liquid crystal panels disposed on the different areas of the machine have different temperatures, and the liquid crystal panels on the different areas form a same pre-tilt angle to improve a product performance of each product when a production of products having different sizes on a same substrate is performed. The liquid crystal panels having same characteristic parameters are disposed on adjacent areas of the machine, such that the liquid crystal panels disposed on different areas of the machine have a same temperature, so as to adapt to a single size of a production of large-size panels, flexible and convenient to the production.

The present disclosure has been described with a preferred embodiment thereof. The preferred embodiment is not intended to limit the present disclosure, and it is understood that many changes and modifications to the described embodiment can be carried out without departing from the scope and the spirit of the invention that is intended to be limited only by the appended claims.

What is claimed is:

1. A temperature control alignment device, comprising:
a machine divided into at least two areas;
a plurality of heating modules, each of the heating modules corresponding to each of the areas of the machine; and
a plurality of moving modules, each of the moving modules corresponding to each of the areas of the machine;
wherein adjacent heating modules are connected together by the moving modules when a plurality of liquid crystal panels having same characteristic parameters are disposed on adjacent areas of the machine, and any one of the heating modules makes the liquid crystal panels disposed on different areas of the machine have a same temperature;
wherein the adjacent heating modules are separated by the moving modules when the liquid crystal panels having different characteristic parameters are disposed on the adjacent areas of the machine, and corresponding heating modules make the liquid crystal panels disposed on the different areas of the machine have different temperatures;
wherein each of the heating modules provides a temperature between 20 degrees Celsius and 50 degrees Celsius; each of the heating modules comprises a thermally conductive sheet disposed at a bottom of the machine and matching a size of a corresponding area of the machine, a liquid conduit in contact with the thermally conductive sheet, and an electric heater in contact with liquid in the liquid conduit, and the electric heater is configured to heat the liquid.

2. The temperature control alignment device according to claim 1, wherein a difference between temperatures provided by the adjacent heating modules is between 10 degrees Celsius and 20 degrees Celsius when the liquid crystal panels having different characteristic parameters are disposed on the adjacent areas of the machine.

3. The temperature control alignment device according to claim 1, wherein each of the moving modules is connected to the thermally conductive sheet of a corresponding heating module.

4. The temperature control alignment device according to claim 3, wherein the moving modules combine adjacent thermally conductive sheets together to make the thermally conductive sheets have a same temperature when the liquid crystal panels having the same characteristic parameters are disposed on the adjacent areas of the machine.

5. The temperature control alignment device according to claim 3, wherein the moving modules separate adjacent thermally conductive sheets to make the thermally conductive sheets have different temperatures when the liquid crystal panels having the different characteristic parameters are disposed on the adjacent areas of the machine.

6. The temperature control alignment device according to claim 3, wherein each of the thermally conductive sheets is a copper sheet or an aluminum sheet.

7. The temperature control alignment device according to claim 1, wherein each of the heating modules further comprises a controller connected to the electric heater for controlling a temperature of the electric heater.

8. The temperature control alignment device according to claim 7, wherein each of the heating modules further comprises a temperature sensor disposed in the liquid conduit, and the temperature sensor is connected to the controller.

9. A temperature control alignment device, comprising:
a machine divided into at least two areas;
a plurality of heating modules, each of the heating modules corresponding to each of the areas of the machine; and
a plurality of moving modules, each of the moving modules corresponding to each of the areas of the machine;
wherein adjacent heating modules are connected together by the moving modules when a plurality of liquid crystal panels having same characteristic parameters are disposed on adjacent areas of the machine, and any one of the heating modules makes the liquid crystal panels disposed on different areas of the machine have a same temperature;
wherein the adjacent heating modules are separated by the moving modules when the liquid crystal panels having different characteristic parameters are disposed on the adjacent areas of the machine, and corresponding heating modules make the liquid crystal panels disposed on the different areas of the machine have different temperatures.

10. The temperature control alignment device according to claim 9, wherein each of the heating modules provides a temperature between 20 degrees Celsius and 50 degrees Celsius.

11. The temperature control alignment device according to claim 9, wherein a difference between temperatures provided by the adjacent heating modules is between 10 degrees Celsius and 20 degrees Celsius when the liquid crystal panels having different characteristic parameters are disposed on the adjacent areas of the machine.

12. The temperature control alignment device according to claim 10, wherein a difference between temperatures provided by the adjacent heating modules is between 10 degrees Celsius and 20 degrees Celsius when the liquid crystal panels having different characteristic parameters are disposed on the adjacent areas of the machine.

13. The temperature control alignment device according to claim 9, wherein each of the heating modules comprises a thermally conductive sheet disposed at a bottom of the machine and matching a size of a corresponding area of the machine, a liquid conduit in contact with the thermally conductive sheet, and an electric heater in contact with liquid in the liquid conduit, and the electric heater is configured to heat the liquid.

14. The temperature control alignment device according to claim 13, wherein each of the moving modules is connected to the thermally conductive sheet of a corresponding heating module.

15. The temperature control alignment device according to claim 14, wherein the moving modules combine adjacent thermally conductive sheets together to make the thermally conductive sheets have a same temperature when the liquid crystal panels having the same characteristic parameters are disposed on the adjacent areas of the machine.

16. The temperature control alignment device according to claim 14, wherein the moving modules separate adjacent thermally conductive sheets to make the thermally conductive sheets have different temperatures when the liquid crystal panels having the different characteristic parameters are disposed on the adjacent areas of the machine.

17. The temperature control alignment device according to claim 14, wherein each of the thermally conductive sheets is a copper sheet or an aluminum sheet.

18. The temperature control alignment device according to claim 13, wherein each of the heating modules further comprises a controller connected to the electric heater for controlling a temperature of the electric heater.

19. The temperature control alignment device according to claim 18, wherein each of the heating modules further comprises a temperature sensor disposed in the liquid conduit, and the temperature sensor is connected to the controller.
